(19) United States
(12) Patent Application Publication
(10) Pub. No.: US 2004/0003826 A1
(43) Pub. Date: Jan. 8, 2004

(54) Dental floss (dispenser with floss) Intermittently laminated throughout the roll

(76) Inventor: Joseph Smith, Boca Raton, FL (US)

Correspondence Address: Dr. Joseph Smith, 7048 Montrico Drive, Boca Raton, FL, 33433, US

(21) Appl. No.: 10/189,835

(22) Filed: Jul. 8, 2002

(51) Int. Cl. A61C 15/00

(52) U.S. Cl. 132/321

(57) ABSTRACT

The above and related objects are achieved by providing a device comprising stiffened laminated gaps throughout a roll of dental floss with regular and/or spongy floss allowing increased ability to clean teeth, braces and/or bridges and clean plaque for anyone using a roll of dental floss.

### BACKGROUND OF THE INVENTION

1. Field of the Invention

This invention relates to an article of manufacture. More specifically, this invention is directed to a device and a method to clean teeth, bridge and/or brace in the mouth. In the preferred embodiments of this invention, the device comprises a laminated dental floss threading product (stiffened plastic threader) excellent for the everyday care of teeth and for cleaning around braces and bridges and wide open spaces. It consists of a continuous roll of dental floss with measured spaces of stiffened plastic gaps throughout the roll instead of pre-cut separate pieces.

2. Description of the Prior Art

The teeth in the mouth can be damage by debris trapped between teeth. To prevent this, it has been found advantageous to clean the teeth with floss. Typically this has been done by either a roll of floss for normal teeth and for braces and/or bridges there have been different applications of dental floss made of pre-cut strands.

### OBJECTS OF THE INVENTION

It is the object of this invention to remedy the above as well as related deficiencies in the prior art. More specifically, it is the principal object of the present invention to provide a roll of dental floss, whether spongy or regular floss with measured spaces of stiffened plastic (laminated) gaps throughout the roll to enable all individuals to be able to floss their teeth, clean their bridge or brace with a roll of dental floss without many having to purchase individuals pre-cut strands.

### SUMMARY OF THE INVENTION

The above and related objects are achieved by providing a continuous roll of dental floss with measured gaps throughout the roll with regular and/or spongy floss to more easily enable individuals to be able to use dental floss in a roll for home or travel whether for cleaning normal teeth, braces and/or bridge.

### BRIEF DESCRIPTION OF THE DRAWINGS

FIG. 1 is a perspective view of the dental floss. The laminated gaps are spaced throughout the floss.

### DETAILED DESCRIPTION OF THE INVENTION INCLUDING PREFERRED EMBODIMENTS

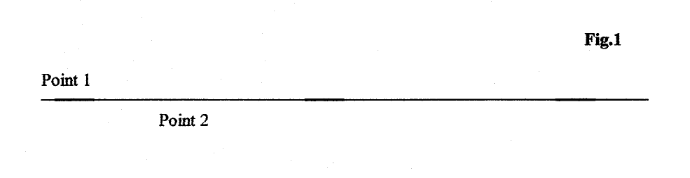

FIG. 1 is a perspective view of the dental floss. Point 1 is the area of the dental floss that is stiffened (laminated) for threading the floss, regular and/or spongy, between teeth, braces and/or bridges. Point 2 is a perspective of the area of the dental floss, regular and/or spongy, that is used to clean the teeth, braces and/or bridges.

What is claimed is:

1. In this device for cleaning teeth, braces and/or bridges the device comprises laminated, stiffened gaps placed throughout the roll of dental floss (regular and/or spongy), which allows any user to cut of a piece and use it to clean either their teeth, braces and/or bridges for easier use to keep the teeth clean and remove plaque and keep the mouth healthier.
